(19) United States
(12) Patent Application Publication
(10) Pub. No.: US 2003/0123693 A1
(43) Pub. Date: Jul. 3, 2003

(54) Elastic fabric cloth knitted with conductive wires

(76) Inventor: Hiroshi Ohara, Taipei (TW)

Correspondence Address: SUPREME PATENT SERVICES, POST OFFICE BOX 2339, SARATOGA, CA, 95070, US

(21) Appl. No.: 10/039,594

(22) Filed: Dec. 31, 2001

(51) Int. Cl. H04R 1/00; H04R 9/06; H04R 11/02

(52) U.S. Cl. 381/409; 381/410; 381/403

(57) ABSTRACT

A kind of elastic fabric cloth (damper) is exclusively installed in a loud speaker. The fabric cloth is firstly cross-knitted with numerous fiber threads to form a wafer, then hot-pressed by molding to become a disk with corrugated annular strips on its surface. A plurality of conductive wires is aligned to penetrate gaps of the fiber threads of the fabric cloth and glued or fastened to the top ends or the root portions of the annular strips to thereby stably fix the conductive wires onto the fabric cloth without spoiling the strength and elasticity thereof.

### BACKGROUND OF THE INVENTION

The fabric cloth (damper) used exclusively in a loud speaker is fitted between a sound ring and the housing of the speaker, and a metallic whisker (conductive wire) is suspended over the fabric cloth and connected with a signal terminal and the sound ring. When a train of audio signals is transmitted to drive the speaker to sound, the whisker is vibrated up and down to incur the so-called jump-rope phenomenon that might have a part or the entire twist thread of the whisker broken or ruptured sooner or later.

In view of abovesaid defect, some makers have proposed to knit the metallic whisker in the fabric cloth when weaving the latter before forming it into a circular disk with a corrugated surface to thereby prevent the whisker from being ruptured under drastic jittering. However, the metallic whisker seems liable to get ruptured during weaving and the worst part is that it is rather difficult for people to find out any broken point for splicing or repairing as the whisker is invested by the fabric cloth that would badly degrade the speaker.

### SUMMARY OF THE INVENTION

The primary object of this invention is to provide a kind of elastic fabric cloth knitted with conductive wires, in which the conductive wires are combined with the elastic fabric cloth without spoiling the architecture thereof.

In order to realize abovesaid object, the fabric cloth (damper) to be installed in a loud speaker is firstly cross-knitted with numerous fiber threads to form a wafer, then hot-pressed by molding to become a disk with corrugated annular strips on its surface. Furthermore, a plurality of conductive wires is aligned to penetrate gaps of the fiber threads of the fabric cloth and glued or fastened to the top ends or the root portions of the annular strips to thereby stably fix the conductive wires onto the fabric cloth without spoiling the strength and elasticity thereof.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 shows an embodiment (1) of this invention;

FIG. 2 shows a cutaway section of the embodiment (1) of this invention;

FIG. 3 shows an embodiment (2) of this invention;

FIG. 4 shows a cutaway section of the embodiment (2) of this invention;

FIG. 5 shows an embodiment (3) of this invention; and

FIG. 6 shows a cutaway section of the embodiment (3) of this invention.

### DETAILED DESCRIPTION OF THE INVENTION

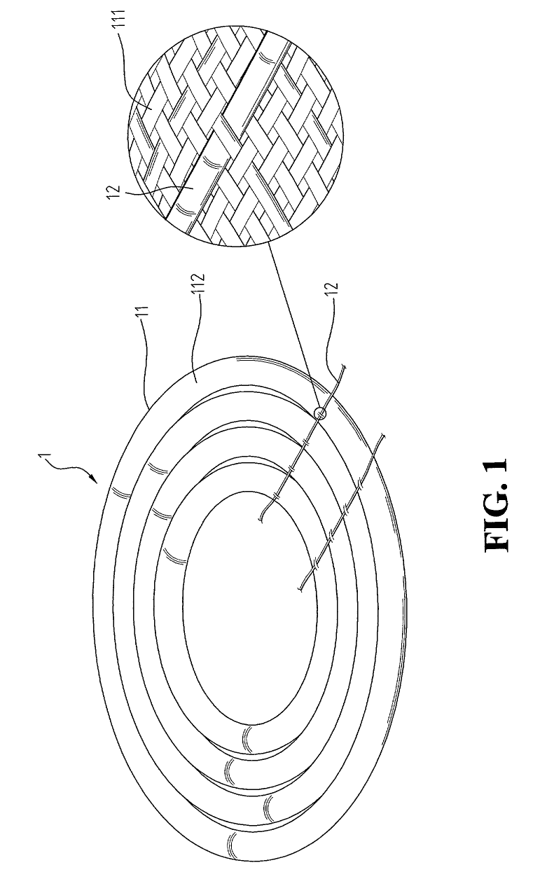

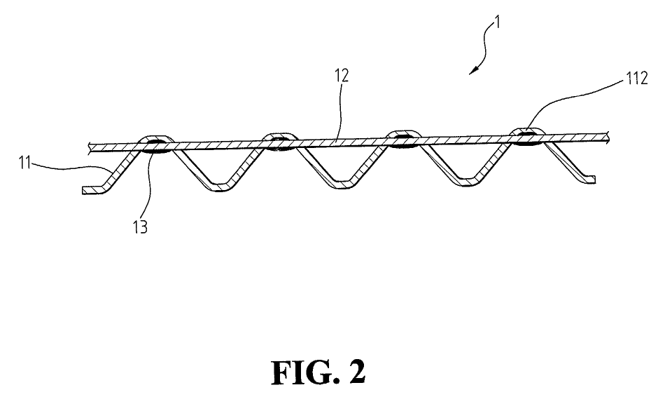

As illustrated in FIGS. 1 and 2, a kind of elastic fabric cloth knitted with conductive wires 1 for being utilized exclusively in speakers, in which the fabric cloth 11 is a wafer cross-woven with numerous fiber threads 111, then molded by hot-pressing to form a disk having a plurality of corrugated annular strips 112 in order to strengthen the fabric cloth 11 for bearing a vertical and a horizontal force and raise its elasticity for immediate restoration after removal of the force applied.

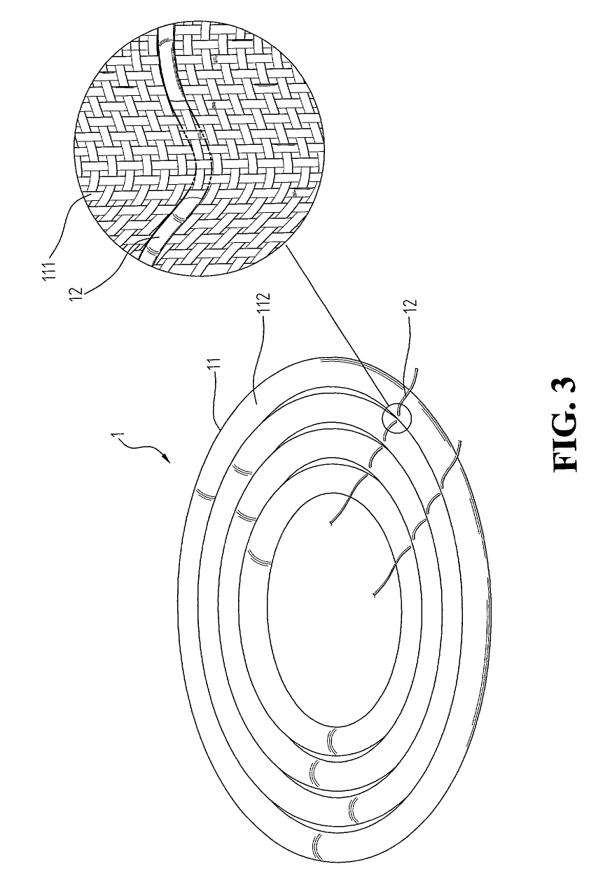

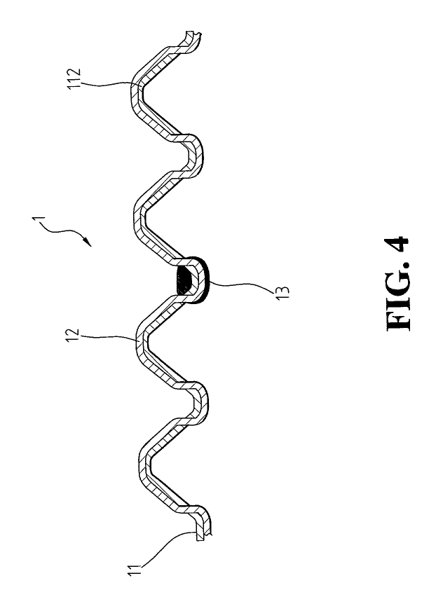

Furthermore, several conductive wires 12, which are penetratingly buried in the fabric cloth 11 by taking advantage of the gaps among the fiber threads 111, are composed of a plurality of metallic twist threads. Also, the conductive wires 12 are penetratingly disposed at the top portions (shown in FIGS. 1, 2) or at the root portions (shown in FIGS. 3, 4) of the annular strips 112.

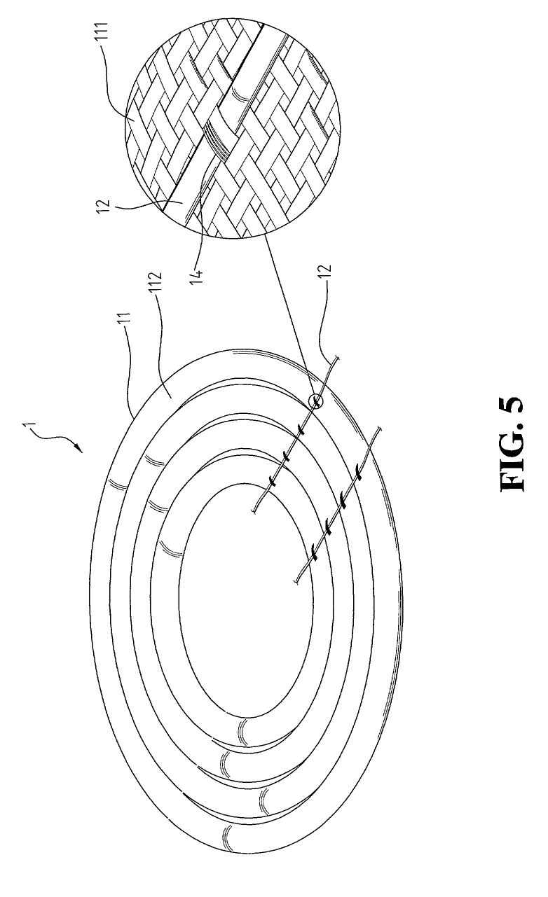

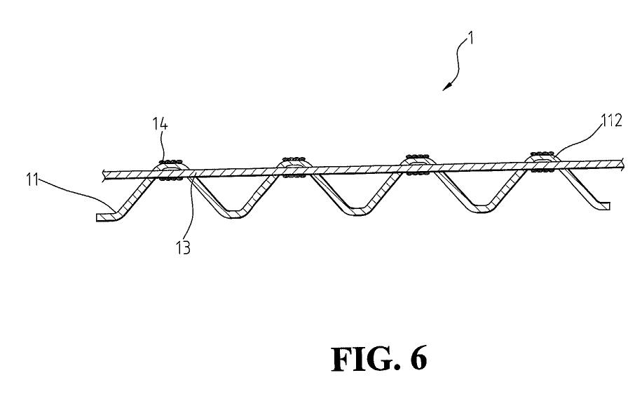

In the former manner, the conductive wires 12 might be further glued to fixedly joint with the fiber threads 112 with a binder 13, and on the other hand in the latter manner, the conductive wires 12 penetrate the gaps of the fiber threads 111 on lateral edges of the annular strips 112 and are glued and bound to the fiber threads 111 as mentioned above. Alternatively, the conductive wires 12 and the fabric cloth 11 might be tied together with a string 14 as shown in FIGS. 5 and 6, then the conductive wires 12 are supposed to go through the gaps of the fiber threads 111 located laterally to the root portions of the annular strips 112, such that the conductive wires 12 are attached onto the circumferential surface of each annular strip 112 to achieve the purpose of combining the conductive wires 12 with the fabric cloth 11 without spoiling the strength and elasticity of the fabric cloth 11. Besides, as the conductive wires 12 are either fully attached to the entire circumferential surface of the annular strips 112 or strained in a straight line, there wouldn't be any jump-rope phenomenon resulted at all.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A kind of elastic fabric cloth knitted with conductive wires, in which a plurality of conductive wires is combined with the elastic fabric cloth without spoiling the architecture thereof and the fabric cloth is employed exclusively in a loud speaker and firstly cross-knitted with numerous fiber threads to form a wafer, then hot-pressed by molding to become a disk with corrugated annular strips on its surface; and a plurality of conductive wires is aligned in the fabric cloth, in which the conductive wires penetrate through gaps of the fiber threads in a straight line along the top ends of the fabric cloth.

2. A kind of elastic fabric cloth knitted with conductive wires, in which a plurality of conductive wires is combined with the elastic fabric cloth without spoiling the architecture thereof and the fabric cloth is employed exclusively in a loud speaker and firstly cross-knitted with numerous fiber threads to form a wafer, then hot-pressed by molding to become a disk with corrugated annular strips on its surface; and a plurality of conductive wires is aligned in the fabric cloth, in which the conductive wires are penetratingly disposed at the root portions of a plurality of annular strips such that the conductive wires can be attached flat on the circumferential surface of the annular strips.

3. The elastic fabric cloth according to claim 1, wherein the positions where the conductive wires penetrate the fiber threads of the fabric cloth are glued.

4. The elastic fabric cloth according to claim 2, wherein the positions where the conductive wires penetrate the fiber threads of the fabric cloth are glued.
